(19) United States
(12) Patent Application Publication
(10) Pub. No.: US 2005/0224334 A1
(43) Pub. Date: Oct. 13, 2005

(54) Adaptable distillation column

(76) Inventor: Ricky Albert Morris, Keller, TX (US)

Correspondence Address: Rick A. Morris, 4824 Carolina Trace Trail, Keller, TX, 76248, US

(21) Appl. No.: 10/822,261

(22) Filed: Apr. 12, 2004

(51) Int. Cl. B01D 3/10

(52) U.S. Cl. 202/237; 202/269

(57) ABSTRACT

A distillation column design to improve the efficiency and effectiveness of the cooling method which results in improved purity, and to increase the adaptability of the distillation column for multifunction use from a single apparatus.

### BACKGROUND OF THE INVENTION

1. Field of the Invention

The present invention relates to distillation and in particular to a distillation column design for increasing versatility and improving purity of distillate over other distillation column designs for use in small scale distilling. Small scale distilling is considered to be distillation volumes of no more than 100 gallons.

2. Description of the Prior Art

Distillation is an art enjoyed by many individuals and small scale commercial distilleries with a satisfying product to enjoy at the end of the process. There can be creativity in producing a variety of products such as essential oils, distilled vinegars, and alcohol.

Standard distillation columns are designed for a single method of use, limiting the users ability to distill varying products or by a variety of methods to produce the specific desired results.

Standard reflux distillation columns utilize a method of cooling that does not maximize the ability and efficiency of the distillation column, which results in decreased purity of the resulting distillate.

### SUMMARY OF THE INVENTION

An object of the present invention is to provide an improved cooling design to the small scale reflux distillation column which will produce a distillate of increased purity.

Another object of the present invention is to increase the versatility of the small scale distillation column by creating a method for the distiller to adapt the column to their specific individual distillation requirements on an individual distillation process basis.

In brief an adaptable distillation column and method comprises adding a base product to a boiling vessel and attaching a distillation column to the boiling vessel by a method where a seal is created between the boiling vessel and the distillation column. Heat is added to the boiling vessel sufficient to cause the product inside of the boiling vessel to boil. The vapor created by boiling the base product rises into the adaptable distillation column where it may or may not be condensed and vaporized repeatedly depending on the distillation method chosen, prior to exiting the distillation column. Vapor exiting the adaptable distillation column is condensed to liquid form and subsequently collected by the distiller.

The present invention has a primary advantage in that it produces reflux nearer the top of the distillation column when used in the associated mode when compared to other distillation columns.

Another advantage of the present invention is that the adaptable distillation column may be used for a larger range of distillation methods than other small scale distillation columns.

A related advantage of the present invention is that distillate produced when the adaptable distillation column is used in reflux distillation mode will be of increased purity.

Another related advantage of the present invention is that the distillate produced when the adaptable distillation column is used in traditional distillation mode will be of increased bouquet and flavor.

### BEST MODE FOR CARRYING OUT THE INVENTION

An adaptable distillation column comprises tubing made of metal or plastic of at least 1.5 inches in diameter and at least 8 inches in length to which a hole is drilled near one end of the tubing and a length of smaller diameter tubing leading to a method of condensing the vapor is attached and sealed. One or more lengths of tubing smaller in diameter than the larger diameter tubing and sufficient in length to protrude at least 0.15 inches on both sides of the larger diameter tubing are placed directly through the larger diameter tubing through holes drilled on opposing sides of the tubing. The connections between the larger diameter tubing and smaller diameter tubing are sealed to avoid any vapor escaping during use in distillation. A connector is attached and sealed to the opposite end of the larger diameter tubing of a type that will allow the adaptable distillation column to be temporarily connected to a boiling vessel by a sealed connection. One or more lengths of larger diameter tubing with an identical style of connector to that on the adaptable distillation column attached and sealed to one end of the tubing, while a connector identical to that on the boiling vessel is attached and sealed to the opposite end of the tubing may be used to create an adaptable distillation column. One or more pieces of the larger diameter tubing may have a screen put in place on the bottom side of the tubing to hold in a material that may be placed into the tubing while allowing vapor to rise through the tubing.

An adaptable distillation column comprises:

A length of tubing with an attached method of condensing vapor, plus one or more lengths of smaller diameter tubing placed directly through the larger diameter column known as cooling tubes. The smaller diameter tubing can be used to carry water or another liquid through the larger diameter column for the purpose of cooling vapor that is rising through the larger diameter column. A connector sufficient to attach and seal the tubing to a boiling vessel

One or more lengths of larger diameter tubing with connectors sufficient to attach to both a boiling vessel and the adaptable distillation column may be used for the purpose in increasing the total length of the adaptable distillation column.

It is understood that the preceding description is given merely by way of illustration and not in limitation of the invention and that various modifications may be made thereto without departing from the spirit of the invention as claimed.

1. An adaptable distillation column comprising:
a length of metal or plastic tubing;
a connector fitting attached and sealed to one end of the tubing, sufficient in type to attach the adaptable distillation column by a temporary sealed connection to a boiling vessel;
one or more lengths of smaller diameter tubing sufficient in length to protrude on both sides of the larger diameter tubing, placed directly through the larger diameter tubing through holes drilled or otherwise created on opposing sides of the larger diameter tubing, wherein the smaller diameter tubing is sealed to the larger diameter tubing and where at least one length of smaller diameter tubing is placed nearer to the location where vapor exits the larger diameter tubing than to the connector fitting;

2. A distillation column wherein additional lengths of larger diameter tubing may be used to increase the total length of the distillation column comprising:
a length of larger diameter tubing with a length of at least 4 inches wherein a connector fitting of the same type as that used on the distillation column is attached and sealed to one end of the larger diameter tubing;
a connector fitting of the same type as that used on the boiling vessel is attached and sealed to the opposite end of the larger diameter tubing.

3. A distillation column wherein the use of more than one length of smaller diameter tubing directly through any portion of the distillation column is not parallel with another length of tubing through the same distillation column.
